(19) United States
(12) Patent Application Publication
(10) Pub. No.: US 2021/0050576 A1
(43) Pub. Date: Feb. 18, 2021

(54) SEPARATOR FOR AN ENERGY STORAGE DEVICE

(71) Applicant: Sparkle Power LLC, Rochester, NY (US)

(72) Inventors: Xing Li, Chengdu (CN); David Mitlin, Hannawa Falls, NY (US)

(21) Appl. No.: 16/991,355

(22) Filed: Aug. 12, 2020

Related U.S. Application Data
(60) Provisional application No. 62/885,432, filed on Aug. 12, 2019.

(51) Int. Cl. H01M 2/16; H01M 10/052

(52) U.S. Cl. CPC H01M 2/1686; H01M 2/1646; H01M 2/1653; H01M 10/052

(57) ABSTRACT

A separator for an electrochemical energy storage device that includes a polypropylene layer and a plurality of ceramic particles selected from at least one of ceramic microparticles and ceramic nanoparticles, wherein the ceramic particles are coated on the polypropylene layer. An electrochemical energy storage device including the aforementioned separator is also disclosed.

### CROSS REFERENCE TO RELATED APPLICATIONS

This application claims priority to provisional patent application No. 62/885,432, filed on Aug. 12, 2019, the entirety of which is incorporated by reference herein.

### FIELD OF THE INVENTION

The present invention relates to electrochemical energy storage devices, and more particularly to improved separators for electrochemical energy storage devices.

### BACKGROUND OF THE INVENTION

Lithium (Li) metal is regarded as one of the best, if not the best, negative electrode material, and also serve as the basis for high energy Lithium Metal Batteries (LMBs). This is due lithium's reversible capacity that is ten times higher than that of graphite (3860 vs. 372 mAh g⁻¹), and its low electrochemical redox potential (−3.040 V vs. SHE) leading to a wide voltage window in full cell.

Having fallen out of favor for the last several decades due to catastrophic dendrite-related failures, LMBs are now again receiving intense scientific attention due to the need for gravimetric energies that are not possible with graphite anode-based lithium ion batteries (LIBs). However commercial applications for LMBs remain confronted by a series of severe challenges related to the instability of the lithium metal anode-electrolyte interface during repeated cycling and during fast charging. The interface instability is manifested in a number of ways, including, for example, early and steady-state low Coulombic efficiency (CE), cycling induced rise in impedance, swelling of flexible cells due to gas generation, and anode to cathode electrical shorting leading to fire hazards. Even if only a fraction (e.g. 30%) of the metal anode volume was stripped and then plated during each cycle, the overall volume change would still be three times larger than the 10% expansion/contraction associated with charging of graphite. This places severe demands on the solid electrolyte interphase (SEI), with its geometric stability being a necessary perquisite safe cell operation.

Lithium metal-electrolyte interface instability is manifested as dendritic morphologies in various forms, often being dictated by the electrolytes employed, the charging rates, electrolyte additives, and metal hosts/supports that are present. Dendrite morphologies have been described as needlelike, moss-like, and treelike Li, with the more densely distributed moss-like structures believed to originate from base growth. Another integral part of a dendrite structure is the “dead Li”, which is trapped and electrically isolated within the SEI layer, and therefore permanently present for the remainder of the cycling regiment.

To become commercially viable, at least the aforementioned problems must be overcome. The present invention is believed to overcome at least a portion of the aforementioned problems.

### SUMMARY OF THE INVENTION

In one aspect of the invention disclosed herein is a methodology of tuning the polymer separator in an electrochemical energy storage device to stabilize the lithium-electrolyte interface during cycling. Another aspect of the invention disclosed herein is a modification of a separator in an electrochemical energy storage device.

In one aspect, the invention is directed to a separator for an electrochemical energy storage device, the separator comprising: a polypropylene layer; and a plurality of ceramic particles selected from at least one of ceramic microparticles and ceramic nanoparticles, wherein the ceramic particles are coated on the polypropylene layer. In one embodiment, the plurality of ceramic particles is ion conducting. In one embodiment, the ceramic microparticles and the ceramic nanoparticles comprise at least one of oxides, carbides, sulfides, selenides, phosphides, nitrides, glass, and metal. In one embodiment, the plurality of ceramic particles become at least partially detached from the polypropylene layer during cycling to form a secondary ion conducting barrier.

In one embodiment of the separator, the plurality of ceramic particles comprises strontium fluoride microparticles.

In another aspect, the invention is directed to a separator for an electrochemical energy storage device, the separator comprising: a polypropylene layer comprising a first surface facing an anode and a second surface facing a cathode; and strontium fluoride (SrF₂) microparticles coated on the first surface of the polypropylene layer.

In a further aspect, the invention is directed to an electrochemical energy storage device comprising: at least one electrode; and a separator, the separator comprising a polypropylene layer; and a plurality of ceramic particles selected from at least one of ceramic microparticles and ceramic nanoparticles, wherein the at least one of the ceramic microparticles and ceramic nanoparticles are coated on the polypropylene layer. In one embodiment, the ceramic particles are ion conducting. In one embodiment, the ceramic microparticles and the ceramic nanoparticles comprise at least one of an oxide, carbide, sulfide, selenide, phosphide, nitride, glass, and metal. In one embodiment, the plurality of ceramic particles comprises strontium fluoride microparticles.

In one embodiment of the electrochemical energy storage device, the at least one of plurality of ceramic particles become at least partially detached from the polypropylene layer during cycling to form a secondary ion conducting barrier.

In one embodiment, the at least one electrode comprises an anode and a cathode. In one embodiment, the polypropylene layer comprises a first surface facing the anode and a second surface facing the cathode; and the plurality of the ceramic particles are coated on the first surface of the polypropylene layer.

In one embodiment, the electrochemical energy storage device is a metal battery or an ion battery. In one embodiment, the electrochemical energy storage device is a lithium ion battery or a lithium metal battery.

These and other aspects are described herein.

### BRIEF DESCRIPTION OF THE DRAWINGS

FIGS. 1(a) and 1(b) are schematic illustrations of an electrochemical storage device in accordance with an embodiment disclosed herein. FIG. 1(a) is a schematic illustration of the outside of the electrochemical storage device, while FIG. 1(b) is a schematic illustration of an electrochemical storage device and the inside contents thereof.

FIGS. 2(a) and 2(b) are scanning electron microscope (SEM) images of ceramic particles according to embodiments described herein.

FIGS. 3(a) and 3(b) are SEM images. FIG. 3(a) is a SEM image of a separator of an electrochemical energy storage device. FIG. 3(b) is a SEM image of ceramic particles coated on a separator.

FIG. 4 is a schematic of a pristine polypropylene (PP) separator as compared to a separator coated with ceramic particles according to the present invention.

### DETAILED DESCRIPTION OF THE INVENTION

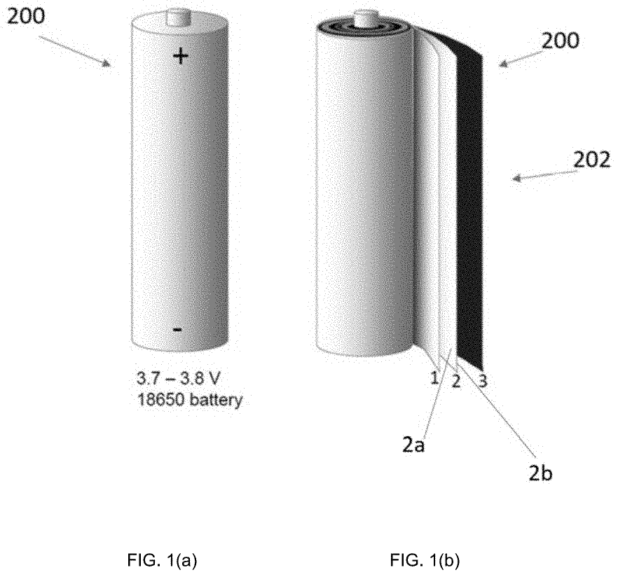

In one aspect, as shown in FIG. 1(a) and FIG. 1(b), the present invention provides a separator 2 for an electrochemical energy storage device 200. An example of an electrochemical energy storage device 200 is shown in FIGS. 1(a) and 1(b). Examples of electrochemical energy storage devices 200 include, but are not limited to, batteries, capacitors, supercapacitors, ultracapacitors, symmetric capacitors, hybrid capacitors, and the like. FIGS. 1 (a) and 1(b) illustrate an 3.7-3.8V, 18650 battery, however the invention is not limited in this regard as any type or style of electrochemical energy storage device is contemplated.

In a particular embodiment, the electrochemical energy storage device 200 is a lithium battery. In one example, the electrochemical energy storage device 200 is a lithium metal battery.

As shown in FIG. 1(b), the electrochemical energy storage device 200 includes, in an interior portion 202, at least one electrode. In the embodiment shown in FIG. 1(b), the device 100 includes a cathode 1, an anode 3, and the separator 2, which are submerged in an electrolyte (not labeled). The separator 2 includes at least two surfaces, 2a and 2b. The first surface 2b faces the anode 3 and the second surface 2a faces the cathode 1.

Examples of materials for anodes and cathodes are generally known in the art. In one particular example, such as a lithium metal battery, the material of anode 3 is lithium and the material of cathode 1 includes, for example, manganese dioxide, carbon monofluoride, iron disulfide, thionyl chloride, thionyl chloride with bromine chloride, sulfuryl chloride, sulfur dioxide on Teflon-bonded carbon, iodine mixed with P2VP, silver chromate, copper sulfide, NCM (lithium nickel manganese cobalt oxide), porous carbon, or selenium, and the like.

Electrolytes are generally known in the art and known separators and electrolytes are acceptable to use in the device 200. In one embodiment, the electrolyte is an organic electrolyte or an aqueous electrolyte. In one embodiment, the electrolyte is LiPF₆—EC:DEC:DMC. In one embodiment, the electrolyte is an organic electrolyte that includes 1.0 M tetraethylammonium tetrafluoroborate (TEATFB) salt in acetonitrile (ACN) solvent. In another embodiment, the electrolyte is a concentrated saline solution. In another embodiment, the electrolyte is Zn(CF₃SO₃)₂. Other known electrolytes can be used in connection with the device 200.

In known devices 200, the separator 2 includes polypropylene (PP) (also referred to as a polypropylene layer). In a device according to embodiments disclosed herein, the separator 2 includes a polypropylene (PP) layer and a plurality of ceramic particles. In one embodiment, the plurality of ceramic particles are coated on at least one surface of the separator 2. In one embodiment, the ceramic particles are coated on the first surface 2b of the separator 2.

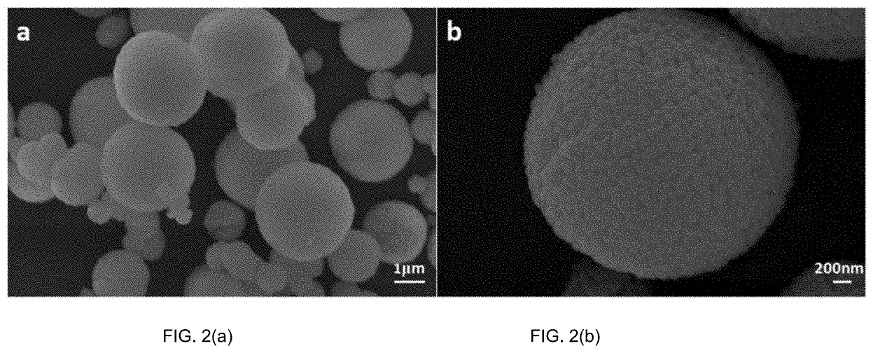

Ceramic particles are shown in more detail in the photographs shown in FIGS. 2(a) and 2(b). FIGS. 2(a) and 2(b) provide SEM images of ceramic particles, and in particular, ceramic microparticles including SrF₂, taken at different magnifications (scale bars on bottom right of images).

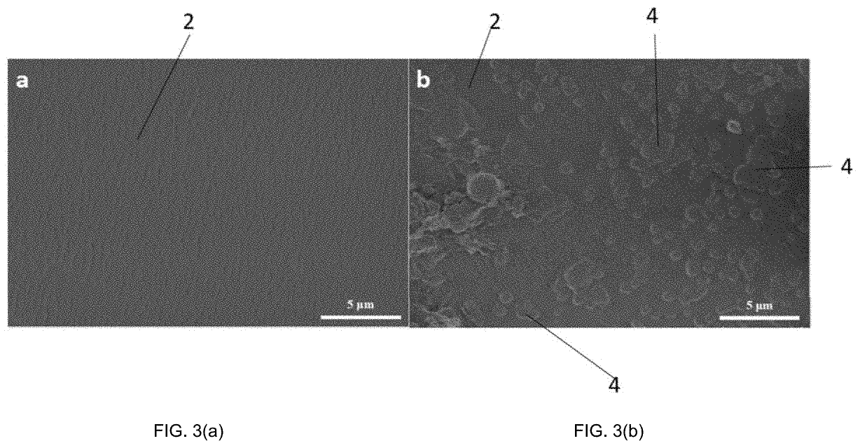

FIG. 3(a) shows an SEM image of a PP separator 2, while FIG. 3(b) shows an SEM image of a PP separator 2 with ceramic particles 4 coated on the PP separator. In particular, the ceramic particles 4 shown in FIG. 3(b) include SrF₂. The ceramic particles 4 can be coated on the separator 2 in one continuous layer, multiple layers, or a non-continuous layer. The term “coated” as used herein encompasses chemical and/or physical bonds between the ceramic particles 4 and the separator 2. It is contemplated that the ceramic particles 4 have physical and/or chemical bonds amongst the particles; however, it is also contemplated that there are no physical and/or chemical bonds amongst the particles.

The ceramic particles 4 are of any shape, including, but not limited to, three-dimensional particles such as spheres, flat particles such as flakes, symmetrical particles, and asymmetrical particles. It is envisioned that the shape of ceramic particles 4 coated on the separator 2 are homogeneous, e.g., all spheres. It is also envisioned that the shape of the ceramic particles 4 coated on the separator 2 are heterogeneous, e.g., a portion of the particles are spheres while another portion of particles are flakes.

The ceramic particles 4 can be any size. In one embodiment, the ceramic particles are meso-size particles (“mesoparticles”), micro-scale particles (“microparticles”), or nano-scale particles (“nanoparticles”); however different sizes of ceramic particles are contemplated. Mesoparticles are particles having a size of 5 millimeters to 0.1 millimeter. Microparticles are particles having a size between 100 micrometers to 0.1 micrometers. Nanoparticles are particles having a size between 100 nanometers to 1 nanometer.

It is contemplated that the ceramic particles 4 coated on the separator 2 include a combination of mesoparticles, microparticles, and/or nanoparticles. In one specific embodiment, the ceramic particles 4 coated on the separator 2 are ceramic microparticles and/or ceramic nanoparticles. In a particular embodiment, the majority (i.e., more than 50%) of the ceramic particle 4 coated on the separator 2 are microparticles. The present invention is not limited in this regard as any ratio of particle sizes can be used to coat the separator 2.

The ceramic particles 4 are porous or non-porous and it is contemplated that the plurality ceramic particle 4 coated on the separator 2 are all porous, all non-porous, or a combination of porous and non-porous. Pore size can vary and it is contemplated that the pores can range in size from nano-sized to micro-sized to meso-sized.

In one embodiment, the plurality of ceramic particles 4 is ion conducting for enhanced ion transfer kinetics and battery rate capability.

In one embodiment, the ceramic particles are ceramic microparticles, ceramic nanoparticles, or a combination thereof. The ceramic particles 4 include at least one of oxides, carbides, sulfides, selenides, phosphides, nitrides, glass, and metal. In a particular embodiment, the ceramic particles 4 are ceramic microparticles, ceramic nanoparticles or a combination thereof, each of the microparticles and nanoparticles include at least one of oxides, carbides, sulfides, selenides, phosphides, nitrides, glass, and metal.

In a particular example, the ceramic particles 4 include strontium fluoride (SrF₂). In another particular example, the ceramic particles 4 are strontium fluoride microparticles.

It is contemplated that the ceramic particles 4 are mixed with other components prior to coating the separator 2. In one example, the ceramic particles 4 are mixed with poly (vinylidene fluoride) (PVDF). In another example, the ceramic particles 4 are mixed with PVDF and a solvent prior to coating the separator 2. Examples of solvents include, but are not limited to water, N-Methyl-2-Pyrrolidone (NMP), and the like. In a particular embodiment, the separator 2 is coated with a mixture that includes 90% ceramic particles 4 and 10% PVDF in a solvent.

In one embodiment, the plurality of ceramic particles become at least partially detached from the polypropylene layer of the separator 2 during cycling to form a secondary ion conducting barrier (not shown). The secondary barrier is created in-situ and supports the primary conventional separator. This barrier will exert a compressive stress on the metal or ion-storing anode, for example on Li, Si or graphite. The barrier is functional, with the particles chemically or electrochemically interacting with the Li, Na, K etc. ion flux to disperse it. It is expected that the chemical interaction will be either repulsive or attractive, for example having ions adsorb at edge sites in the structure or at inner porosity. The particles will strongly bind with solid electrolyte interphase layer, primarily with the organic outer components.

The inventors have surprisingly found that the ceramic particles 4 coated on the separator 2 stabilize the solid electrolyte interphase (SEI) and prevents dendrites from growing. Lithium ions prefer to adsorb onto the ceramic surface, which creates a more uniform ion flux and reduce the propensity for dendrite nucleation. In parallel, the ceramic particles bind with the SEI layer, becoming incorporated in the structure and becoming detached from the separator. This creates a tough in-situ formed composite membrane that mechanically stabilizes a planar metal interface.

The inventors surprisingly found that a layer of ceramic particles coated on the anode side of the separator will keep the plating/stripping metal from developing coarse dendrites by mechanically-electrochemically stabilizing the solid electrolyte interphase (SEI). This is achieved through in-situ creation of a tough composite membrane of ceramic particles imbedded within the SEI layer (mechanical), while the actual ceramic particles homogenize the Li ion flux around them (chemical, electrochemical). A substantial improvement in cycling CE and cycling voltage stability, rate capability, as well as in plating-stripping overpotential is also achieved by the invention disclosed herein.

Certain aspects of particular embodiments of the invention are discussed in more details in the Examples below. The Examples are provided as an illustration of some of the embodiments of the invention and are not provided to limit the scope of the invention in any manner.

### Examples

I. Material Synthesis and Coating of Separator

Ceramic microparticles comprising SrF₂ were prepared by a one step hydrothermal reaction approach. A 0.1 mol/L of strontium nitrate (Sr(NO₃)₂) and 0.05 mol/L sodium tetrafluoroborate (NaBF₄) aqueous solution separately synthesized. Then 0.2 mol trisodium citrate (C₆H₅Na₃O₇) was added into the Sr(NO₃)₂ solution as a dispersant, followed by adding the as-prepared NaBF₄ solution dropwise while vigorously stirring. The resultant product was hydrothermally treated in a polytetrafluoroethylene (PTFE) lined autoclave at 180° C. for 12 hrs. The sample was then cooled to room temperature, centrifugally washed with deionized water, and subsequently dried at 80° C. overnight to obtain the SrF₂ microparticles.

The precursors Sr(NO₃)₂, NaBF₄ and C₆H₅Na₃O₇ were purchased from Shanghai Macklin Biochemical Co. Ltd. A commercial polypropylene (PP) separator (Celgard 2400, 25 μm) was employed.

The separator coating was based on a slurry of 90 wt % as-prepared SrF₂ microparticles and 10 wt % poly (vinylidene fluoride) (PVDF), which were intimately mixed using NMP solvent as the dispersant. The viscous slurry was then cast onto the Li metal facing surface of a conventional polypropylene (PP) separator using a doctor blade technique. The loading amount of SrF₂ microparticles on the surface of the PP separator was about 1.0 mg/cm². The SrF₂ microparticle coated PP separator was further dried at 60° C. under vacuum overnight.

II. Analytical Characterization

Powder X-ray diffraction XRD (Panalytical X'pert MPD DY1219, Cu K_{α} radiation) was employed to characterize the crystal structure of the as-prepared SrF₂ microparticle. The morphologies of the SrF₂ microparticles and the SrF₂ microparticles coated onto the PP separator were also characterized by scanning electron microscopy (SEM, Hitachi SU8010). Surfaces and the cross-sections on the Li metal anodes with different Li deposition thickness and cycle numbers were also characterized by the SEM analysis. X-ray photoelectron spectroscopy (XPS, Phi 5000 Versaprobe iii) was conducted to analyze the solid electrolyte interphase (SEI) composites on the Li metal surfaces.

III. Electrochemical Characterization

Electrochemical analysis was carried out using CR2032 coin cells (MTI Corporation). The cycling and rate performance of the cells was evaluated using BTS-5V20 mA cell galvanostatic testing instruments (NEWARE Electronic Co., Ltd). The coin cell assembly was conducted in a high-purity argon filled glove box with the water and oxygen contents both less than 0.1 ppm. Unless otherwise stated, tests were performed at 30° C. The coated separator was tested in a symmetrical Li metal-Li metal (termed and Li—Cu (termed “Li:Cu”) current collector configuration. The Li metal anodes were purchased from MTI Corporation. The electrolyte for the Li∥Cu and Li∥Li coin cells was 1 mol/L LiPF₆—EC:DEC:DMC (1:1:1). The Li∥Cu cells were tested at charge/discharge current density of 0.25 mA cm⁻² and a deposited capacity of 0.5 mAh cm⁻² with a voltage range of 0-1 V. The cells were tested at a current density of 0.25 mA/cm² and a charge/discharge capacity of 0.5 mAh cm⁻². The SrF₂ coated separator was also tested in a full-cell configuration versus an NCM (LiNi_{0.68}Co_{0.1}Mn_{0.22}O₂) cathode previously reported. An electrolyte solution of 1 mol/L LiPF₆—EC:DEC:DMC (1:1:1 by vol.) electrolyte was employed. In all cases, only one side of the separator was coated by the SrF₂ microspheres, in the full cell and Li∥Cu being the side that faced the Li metal.

The full cell cathode containing 90 wt % NCM, 5 wt % poly (vinylidene fluoride) (PVDF) and 5 wt % acetylene black (AB). The amount of active material (NCM) in the cathode was about 5 mg/cm². For the full cells the voltage range was 2.7-4.4 V. For the Li∥NMC cells, commercial battery representative constant-current charge followed by a constant-voltage charge to 4.4 V was used for the charge step. Current densities of C/10, C/3, 1C, 2C, 3C, 5C, 10C and 20C were employed for the Li∥NCM coin cells testing, where 1C=200 mA g⁻¹ (capacity of LiNi_{0.68}Co_{0.1}Mn_{0.22}O₂ at 20 mA g⁻¹). Electrochemical impedance spectroscopy (EIS) was performed on the cells after different cycle numbers using CH Instruments CHI660D. Measurement was performed in the charged state of 4.1 V, at the frequency ranging from 10⁵ to 10⁻² Hz, with a potential perturbation amplitude of 10 mV.

IV. Morphology

FIGS. 2(a) and 2(b) present the morphology of the as-prepared SrF₂ microparticles, which range in diameters from sub-1 micrometer to about 5 micrometers. Shown are SEM images of the as-synthesized SrF₂ microparticles, taken at different magnifications (scale bars on bottom right). According to the higher magnification image in FIG. 2(b), it may be observed that microparticles consist of an assembly of sub-100 nm crystallites, interspersed with nanoporosity. X-ray diffraction peaks of the as-prepared sample corresponds well to the pure equilibrium phase of SrF₂ (Fm-3m #225 a=0.57996 nm), as referenced to the SrF₂ PDF card (#06-0262). FIGS. 3(a) and 3(b) show the SEM images of the pristine PP separator and of the SrF₂ microparticles coated PP separator, respectively. As FIG. 3(b) illustrates, the SrF₂ microparticles completely and uniformly coat on PP separator surface. A high degree of lithium ion permeable pathways are expected to be present in the coating both due to the microscopic spacing between the particles and due to the nanopores within the individual nanocrystallites. The SrF₂ microparticles coated PP separator was further characterized to analyze the effect on the porosity and the pore size distribution, comparing these results with the original PP separator. It was observed that the total surface area and pore volume (S_{BFT}, V_{total/BJH}) as well as the Average Pore Distribution (APD) for the SrF₂ coated separator is larger than for the baseline, agreeing with the SEM images that show extensive open nanoporosity within the spheres.

V. Electrochemical Performance

The Li∥Cu half-cells and Li∥Li symmetric cells with the pristine PP (baseline) and the SrF₂ microparticles coated PP separators were evaluated to compare the Coulombic efficiency (CE), the overall cycling stability, and the voltage polarization evolution. The cycling CE of Li∥Cu cells were tested at 0.25 mA cm-2 between 0-1 V vs. Li/Li+. For each cycle, the total plating/stripping capacity was 0.5 mAh cm-2. It was observed that during the first 10 cycles, with the pristine PP and the SrF₂ microspheres coated PP separators the CE are almost the same at about 80%. However, with increasing cycle number, the CE with pristine PP separator beings to rapidly degrade, going to about 10% after the 60 cycles. Without surface modification, the vast majority of the Li becomes trapped in the solid electrolyte interphase (SEI) structure that forms on the Cu at cycle 1 and subsequently grows with every cycle. In contrast, the CE values with the SrF₂ microparticle coating remains at 80% at cycle 100. The Li∥Cu half-cell represents the most aggressive method for testing metal-electrolyte instabilities and that the CE values using both symmetric Li∥Li cells and full Li∥NCM batteries are higher. This is likely due to the bare Cu current collector being itself catalytic towards SEI formation and because at every cycle all the Li metal is fully stripped, leaving behind only remnant SEI on the Cu.

The cycling performances of Li∥Li cells was evaluated at a current density of 0.25 mA cm-2 to a capacity of 0.5 mAh cm-2 per cycle. The SrF₂ microparticle coated PP separator could make the Li∥Li coin cells cycle for about 350 hrs, which is 150 hrs longer than the pristine PP separator. This further demonstrates that the SrF₂ microparticle coating layer could facilitate the formation of a more stable SEI on the Li metal, which is favorable for reducing the electrode polarization and hence improving the cycling stability. Magnified images of early cycling behavior demonstrated the key difference in the planting overpotential with SrF₂ coated versus pristine separators. An onset of severe voltage instability may be qualitatively associated with the onset of severe SEI formation and the associated growth of metal dendrites. In turn the dendrites catalyze more SEI growth on their surface, forming a feedback loop that in a real battery would lead to shorting or catastrophic rise in cell impedance. Even at cycle 1, the cathodic (plating) overpotential is smaller with the SrF₂ coating, being −0.065 V vs. −0.084 V, indicating that the role of the coated separator goes far beyond just blocking the growth of “mature” dendrites, rather altering the early stage SEI formation kinetics.

Testing was performed between in the batter-representative range of 2.7-4.4 V at C/3 (1C=200 mA g-1). Prior to that current density regimen, three formation cycles at C/10 were done. The Li∥NCM coin cell with the pristine separator shows an initial discharge capacity of 198 mAh g-1 and a CE of 85.1%. At 1C rate, its discharge capacity is 174 mAh g-1, which fades to 157 mAh g-1 after 200 cycles, corresponding to a capacity retention of 90.2%. In contrast, for the Li∥NCM cell with the SrF₂ coated separator, the initial discharge capacity is 209 mAh g-1 with an initial CE of 88.6%. At 1C, its discharge capacity is 173 mAh g-1. The small but not trivial difference in the initial discharge capacities-CEs of the two architectures is important. It highlights the role of the separator modification in influencing early kinetics, prior to when dendrites are likely to exist or at least be large enough to be influential. After 200 cycles, the discharge capacity of the SrF₂ coated specimen is 167 mAh g-1, corresponding to a capacity retention of 96.5%.

The Li∥NCM cell using the SrF₂ coated PP separator demonstrates a smaller polarization at different stage of cycling. We attribute this to a more stable SEI layer with the SrF₂, which at a given cycle is thinner and should yield a lower resistance at every charge-discharge cycle. This conclusion is in agreement with the Li∥Li cell results, where the same trend is observed. Extended cycling performance of Li∥NMC cells with and without SrF₂ was also evaluated at a current density of 2C and an elevated temperature of 60° C. The initial reversible capacity for the SrF₂ containing Li∥NCM cell is 189 mAh g-1. After 200 cycles, this value is 155 mAh g-1, corresponding to a capacity retention of 82.0%. The reversible capacity for prestine Li∥NCM cell is 182 mAh g-1, degrading to 125 mAh g-1 after 200 cycles, i.e. a retention of 67.6%. The SrF₂ containing Li∥NCM also exhibits smaller polarization at different stage of cycling.

The reversible capacity for the Li∥NCM cell with the SrF₂ separator is 210, 193, 177, 165, 157, 145, 125, and 97 mAh g-1 at C/10, C/3, 1C, 2C, 3C, 5C, 10C, and 20C respectively. These are higher than the Li∥NCM with the uncoated separator, being 198, 185, 173, 159, 150, 137, 113 and 85 mAh g-1 at the same currents. An improved rate capability of a full cell, especially at the higher currents could also be related to a lower SEI-related cell resistance. Battery cell electrochemical kinetics are known to drop off with SEI growth, which causes progressively increasing polarization during repeated charging-discharging. A number of factors get worse as the SEI thickens, including ion diffusional limitations within the layer, and increased charge transfer resistance.

VI. Cycled Li Metal Anodes

The morphological and surface structure/chemistry evolution of the post-cycled Li metal anodes were systematically investigated, comparing the SrF₂ coated versus the pristine separator. With the pristine baseline separator, after 1 hour there are isolated islands forming on the surface of Li metal anode. These are attributed to early-stage formation of a non-uniform SEI structure. Such structure would be ultimately associated with dendrite formation since it would result in highly non-uniform mechanical properties and ion diffusion characteristics of the SEI layer. The observation of early-stage heterogeneities also leads to the conclusion that Li metal growth instabilities occur quite early in the process, significantly earlier than what may be detected from conventional galvanostatic data. The time, the surface instabilities in the baseline become more severe, leading to a highly roughened surface after 8 hours. Although the Li metal-SEI morphology does not directly correlate with classical lath-like isolated dendrites known to lead to catastrophic shorting, such a morphology has been observed prior. A highly roughened metal surface with a thick SEI layer will ultimately lead to unacceptable levels of charge-discharge polarization and would kill the cell nevertheless. With the SrF₂ coating, the Li metal morphology still roughens with cycle number, but at a much-reduced rate. Even after 10 hours of cycling the surface was observed to be relatively flat.

An observation regarding the SrF₂ coated samples is that a layer of microparticles is lodged within the SEI layer at all cycle numbers analyzed. The spheres were observed in all micrographs of the Li metal surfaces and confirmed by XPS results. This gives a strong indication that the SrF₂ microspheres are directly involved in SEI growth kinetics, rather than just acting as a secondary mechanical strengthening layer to block mature dendrites from piercing the separator. One may consider the role of the SrF₂ microspheres as that of rigid filler inside the outer SEI layer that is known to be primarily organic. A membrane of an organic SEI with embedded ceramic SrF₂ particles is classic “soft-hard” composite system, based a ductile matrix and rigid non-deformable filler. Such systems are expected to be physically tough, displaying a combination of strength and ductility. It exerts an effective counterforce to prevent the electrolyte interface from geometrically roughening at early stages, before dendrites have a chance to grow. This composite is formed in-situ during cycling as early SEI growth causes it to bind to the SrF₂ sitting on the contacting separator.

An analogous comparison was done with pristine vs. SrF₂ modified full cells, tested for 20, 40, 80, 160 and 200 cycles at 200 mA g⁻¹ for 2 hours per cycle. With the pristine separator, the Li metal surface begins to roughen early in its cycling life and is quite morphologically heterogenous even by cycle 40. Conversely, with the SrF₂ coating the morphology is relatively flat even at cycle 200. These results further highlight the drastic difference in the post-cycled morphology. A highly roughened SEI layer in the baseline is directly contrasted to a substantially smoother metal at identical cycle number with the separator coating. The SrF₂ coating was also effective in stabilizing the Li metal surface at 60° C. and 400 mA g⁻¹.

The pristine vs. coated separators in the as-synthesized state and after cycling were examined. The pristine separator is in the as-received state, while the SrF₂ modified separator is completely coated with no visible holes. The baseline uncoated separator shows clear evidence of SEI adhesion in the form of dark debris covering the surface. Remarkably, the post-cycled SrF₂ coated separator is completely clean, with no evidence or either the SEI of the ceramic microparticles.

The cycled Li∥NCM cells with the pristine versus the SrF₂ coated PP separators were further analyzed using electrochemical impedance spectroscopy (EIS). Analysis was done on Li∥NCM coin cells after 10th, 20th, 40th, 80th, 160th, and 200th cycles, tested at 200 mA g⁻¹ for 2 hrs. per cycle. The results of the fits are shown in Table 1.

TABLE 1
Fitted parameters for the experimental EIS spectra.

| | | 20^{th} | 40^{th} | 80^{th} | 160^{th} | 200^{th} |
|---|---|---|---|---|---|---|
| samples | | cycles | cycles | cycles | cycles | cycles |
| Pristine PP | R_{E} | 5.6 | 5.8 | 5.9 | 6.2 | 6.4 |
| | R_{SEI} | 46.7 | 50.7 | 52.5 | 62.1 | 62.9 |
| | R_{CT} | 312.1 | 532.7 | 816.7 | 1040.0 | 2025.0 |
| SrF₂ Mod-PP | R_{E} | 5.4 | 5.5 | 5.7 | 6.1 | 6.2 |
| | R_{SEI} | 34.8 | 35.7 | 39.9 | 41.0 | 49.7 |
| | R_{CT} | 130.3 | 212.9 | 500.3 | 829.3 | 1599.0 |

The difference in both resistances is substantial and correlates well to the contrasting Li anode morphologies. With the pristine separator the R_{SEI} values are 46.7, 50.7, 52.5, 62.1, 62.9 ohms, at 20^{th}, 40^{th}, 80^{th}, 160^{th}, 200^{th} cycle, respectively. The corresponding R_{SEI} values with SrF₂ are 34.8, 35.7, 39.9, 41.0, 49.7 ohms. The R_{CT} values for using the pristine separator are 312.1, 532.7, 816.7, 1040.0, 2025.0 ohms, at 20^{th}, 40^{th}, 80^{th}, 160^{th}, 200^{th} cycle, respectively. The corresponding R_{CT} values for using the SrF₂ coated separator are also lower, being at 130.3, 212.9, 500.3, 829.3, 1599.0 ohms.

XPS survey spectra of Li metal anodes after different Li deposition times of 1 h, 2 h, 4 h, 8 h, 10 h, or electrochemical cycles of 20, 40, 80, 160 and 200 were analyzed. The SrF₂ microparticles did not affect the species detected in the SEI, which is reasonable since the same electrolyte was employed in both cases. The SEI films contain the same components of the carbonyl group (˜289.0 eV (C═O)), hydrocarbon (˜285.0 eV (C—C/C—H)), and carbide species (283.0-283.5 eV) in C 1s spectra, and the carbonyl (˜531.0 eV (C═O))/ether oxygen (532.0 eV (C—O—C)) in O 1s spectra.

To better understand the SrF₂ microspheres guided Li plating behavior, the First-principles calculations (CASTEP code) was employed to study the interaction between Li ion and the SrF₂. To reveal the nature of Li ion adsorption the calculated band structure and partial density of state (P DOS) of SrF₂ (110) plane with various adsorption sites were analyzed. A marked band separation was observed between band structure and the valence band. The calculated band gap of SrF₂ (110) plane is 5.542 eV, which is smaller than that of the prefect SrF₂. This discrepancy should be attributed to the unsaturated Sr and F atoms on the surface of SrF₂. According to the PDOS profile, the valence band of SrF₂ (110) plane is contributed by the F-2p state. However, the conduction band of SrF₂ (110) plane derives from the Sr-4d state. When Li ion is absorbed, it is found that the Li ion results in Sr-4d and F-2p state migration from the conduction band to the valence band. This result is in good agreement with the XPS results.

According to the structural configuration, the SrF₂ (110) surface was selected and three possible adsorption models: Sr-top site, F-top site and Sr—F-bridge site, respectively. The nature of Li ion adsorption is revealed by the electronic structure. Table 2 lists the calculated adsorption energy and the corresponding bond length of SrF₂ with three adsorption types. The calculated adsorption energy on Sr-top site is larger than zero, which is energetically unfavorable. However, the calculated adsorption energy on F-top site or Sr—F-bridge is smaller than zero. These results show that SrF₂ with F-top site and Sr—F-bridge site are thermodynamically stable at the ground state.

TABLE 2
Calculated adsorption energy, E_{f} (eV/atom), bond
length (Å) of SrF₂ with various adsorption types.

| Type | Meth | E_{f} | Li—Sr | Li—F |
|---|---|---|---|---|
| Sr-top | Cal | 0.1089 | 2.380 | — |
| F-top | Cal | −0.0128 | — | 1.676 |
| Sr—F-bridge | Cal | −0.0283 | 2.501 | 1.759 |

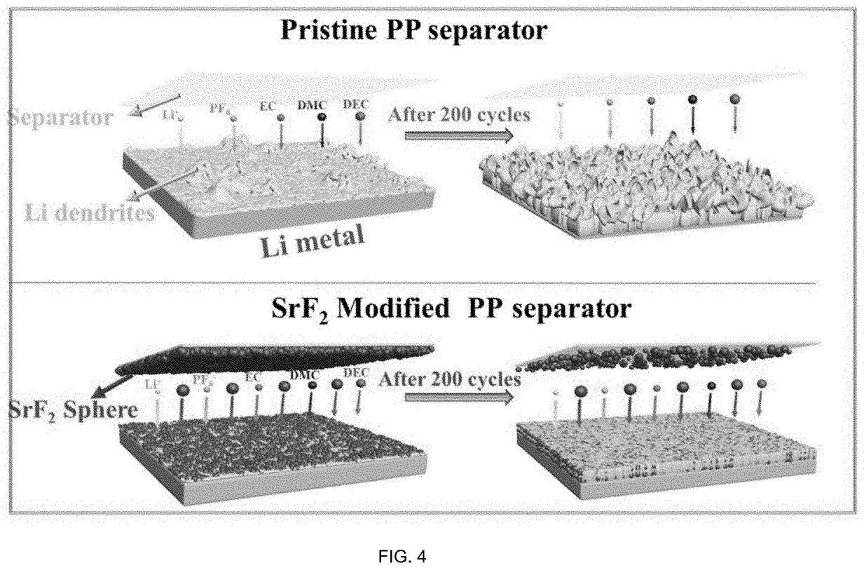

During the charging process of the Li∥NCM cell, electrons transfer from the cathode to the surface of the Li metal anode through the external circuit. The SrF₂ microspheres are in contact with the Li metal would therefore be in the charged state. This should be effective in uniformly dispersing the Li cation flux onto the metal surface, reducing the propensity of localized heterogeneities to form, i.e. early state dendrites. Such an effect however is electrostatic, rather than chemical or electrochemical, and would not be effective purely alone. Instead, it has to be balanced with the driving force for the ions to adsorb onto the exposed SrF₂ (110) planes, per the DFT calculations. In parallel, the SrF₂ microspheres involved in the formation of SEI film also play the roles of rigid fillers, which will make the SEI film more compact and mechanically strong. It was demonstrated that the ceramic spheres bind with the SEI layer, creating an in-situ formed polymer-ceramic microcomposite that mechanically stabilizes a planar metal interface. FIG. 4 provides a comparison schematic for the SrF₂ coated versus the baseline separators, illustrating the core differences in resultant Li metal-electrolyte interfacial stability.

A detailed comparison of this work with the previously reported separator studies is found in Table 3. A unique aspect of this study as compared to prior art is that the proposed dendrite prevention mechanism is both electrochemical and mechanical in nature, with the ceramic microparticles having a dual role.

TABLE 3
A broad comparison of various approaches for suppression of Li dendrites,
with comments regarding the demonstrated or proposed working mechanisms.

| | | Refs. Listed |
|---|---|---|
| Approach | Working Mechanisms | in provisional |
| Separator coated with functional | chemical (electrochemical) - mechanical | This work |
| SrF₂ microspheres | stabilization ceramic-SEI composite and | |
| | homogenize of Li flux | |
| Layer-by-layer assembling | Smaller pore sizes to suppress the Li | [55] |
| polyethylene oxide (PEO) | dendrites from piercing the separator | |
| Elastomeric solid-electrolyte | Nanoporosity and high mechanical strength | [56] |
| separator | to suppress the Li dendrites piercing | |
| Kimwipe paper | Uniform Li-ion distribution on the interface | [60] |
| | to suppress the Li dendrite growth | |
| Coating separator with | High mechanical strength and uniform ionic flux | [57] |
| N,S-co-doped graphene nanosheets | to suppress the Li dendrite growth and piercing | |
| Coating separator with Al₂O₃ | High mechanical strength to suppress the Li | [58] |
| | from piercing the separator | |
| Coating separator with conductive | Uniform interface and high ionic conductivity | [59] |
| polymers, | to suppress Li dendrite growth | |
| Coating separator with | Controlling dendrites growth direction to suppress | [61] |
| functionalized nanocarbon | Li dendrites from piercing the separator | |
| Coating separator with ultrathin | Conductive interface and high mechanical strength | [62] |
| Cu film | to suppress the Li dendrites growth and piercing | |
| Coating separator with polydopamine | Uniform ionic flux to suppress Li dendrite growth | [63] |
| Coating separator with 3D porous | High ionic conductivity to suppress Li | [67] |
| ZSM-5 | dendrite growth | |
| Coating separator with ZrO₂/POSS | High ionic conductivity and interfacial | [68] |
| | stability to suppress Li dendrite growth | |

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A separator for an electrochemical energy storage device, the separator comprising:
a polypropylene layer; and
a plurality of ceramic particles selected from at least one of ceramic microparticles and ceramic nanoparticles,
wherein the ceramic particles are coated on the polypropylene layer.

2. A separator according to claim 1, wherein the plurality of ceramic particles is ion conducting.

3. A separator according to claim 1, wherein the ceramic microparticles and the ceramic nanoparticles comprise at least one of oxides, carbides, sulfides, selenides, phosphides, nitrides, glass, and metal.

4. A separator according to claim 1, wherein the plurality of ceramic particles become at least partially detached from the polypropylene layer during cycling to form a secondary ion conducting barrier.

5. A separator according to claim 3, wherein the plurality of ceramic particles comprises strontium fluoride microparticles.

6. A separator for an electrochemical energy storage device, the separator comprising:
a polypropylene layer comprising a first surface facing an anode and a second surface facing a cathode; and
strontium fluoride (SrF₂) microparticles coated on the first surface of the polypropylene layer.

7. An electrochemical energy storage device comprising:
at least one electrode; and
a separator, the separator comprising:
a polypropylene layer; and
a plurality of ceramic particles selected from at least one of ceramic microparticles and ceramic nanoparticles,
wherein the at least one of the ceramic microparticles and ceramic nanoparticles are coated on the polypropylene layer.

8. The electrochemical energy storage device according to claim 7, wherein the ceramic particles are ion conducting.

9. The electrochemical energy storage device according to claim 7, wherein the ceramic microparticles and the ceramic nanoparticles comprise at least one of an oxide, carbide, sulfide, selenide, phosphide, nitride, glass, and metal.

10. The electrochemical energy storage device according to claim 9, wherein the plurality of ceramic particles comprises strontium fluoride microparticles.

11. The electrochemical energy storage device according to claim 7, wherein the at least one of the ceramic microparticles and the ceramic nanoparticles become at least partially detached from the polypropylene layer during cycling to form a secondary ion conducting barrier.

12. The electrochemical energy storage device according to claim 7, wherein the at least on electrode comprises an anode and a cathode.

13. The electrochemical energy storage device according to claim 12, wherein the polypropylene layer comprises a first surface facing the anode and a second surface facing the cathode; and
the plurality of the ceramic particles coated on the first surface of the polypropylene layer.

14. The electrochemical energy storage device according to claim 7, selected from a metal battery and an ion battery.

15. The electrochemical energy storage device according to claim 14, comprising a lithium ion battery or a lithium metal battery.
